(19) United States
(12) Patent Application Publication
(10) Pub. No.: US 2010/0329072 A1
(43) Pub. Date: Dec. 30, 2010

(54) Methods and Systems for Integrated Material Processing

(76) Inventors: Ed B. Hagan, Hastings, OK (US); Leonard R. Case, Duncan, OK (US); Calvin L. Stegemoeller, Duncan, OK (US)

Correspondence Address: JOHN W. WUSTENBERG, P.O. BOX 1431, DUNCAN, OK, 73536, US

(21) Appl. No.: 12/494,457

(22) Filed: Jun. 30, 2009

(51) Int. Cl. B01F 15/00

(52) U.S. Cl. 366/163.2

(57) ABSTRACT

Methods and systems for integrally processing the materials used in oilfield operations are disclosed. An integrated material processing system is disclosed with a storage unit resting on a leg. A feeder couples the storage unit to a first input of a mixer and a pump is coupled to a second input of the mixer. The storage unit contains a solid component of a well treatment fluid. The feeder supplies the solid component of the well treatment fluid to the mixer and the pump supplies a fluid component of the well treatment fluid to the mixer. The components are mixed in the mixer and the mixer outputs a well treatment fluid.

### BACKGROUND

The present invention relates generally to oilfield operations, and more particularly, to methods and systems for integrally processing the materials used in oilfield operations.

Oilfield operations are conducted in a variety of different locations and involve a number of equipments, depending on the operations at hand. The requisite materials for the different operations are often hauled to and stored at the well site where the operations are to be performed.

Considering the number of equipments necessary for performing oilfield operations and ground conditions at different oilfield locations, space availability is often a constraint. For instance, in well treatment operations such as fracturing operations, several wells may be serviced from a common jobsite pad. In such operations, the necessary equipment is not moved from wellsite to wellsite. Instead, the equipment may be located at a central work pad and the required treating fluids may be pumped to the different wellsites from this central location. Accordingly, the bulk of materials required at a centralized work pad may be enormous, further limiting space availability.

For instance, in normal fracturing operations, proppant or sand is combined with a fracturing fluid in a blender and then pumped by high pressure pumps into the well bore. Depending on the reservoir and well requirements, a large volume of materials may be required on location. In some pad frac applications several well bores may be treated without moving the fracturing equipment, therefore requiring up to 2,000,000 pounds of materials in a 24 hour period. The typical volume for a trailer storage device is often between 2500 sks to 3200 sks. As a result, an area of over 14000 square feet may be required for storing the 2,000,000 pounds of materials which is necessary for some pad frac applications. Considering the limitations on space availability on the field, the large footprint necessary for the oilfield equipment is undesirable.

### FIGURES

Some specific example embodiments of the disclosure may be understood by referring, in part, to the following description and the accompanying drawings.

FIG. 1 is a side view of an Integrated Material Processing System in accordance with a first exemplary embodiment of the present invention.

FIG. 2 is a side view of an Integrated Material Processing System in accordance with a second exemplary embodiment of the present invention.

FIG. 3 is a side view of an Integrated Material Processing System in accordance with a third exemplary embodiment of the present invention.

FIG. 4 is a side view of an Integrated Material Processing System in accordance with a fourth exemplary embodiment of the present invention.

FIG. 5 is a view of an exemplary storage unit of the Integrated Material Processing System of FIG. 4.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### SUMMARY

The present invention relates generally to oilfield operations, and more particularly, to methods and systems for integrally processing the materials used in oilfield operations.

In one exemplary embodiment, the present invention is directed to an integrated material processing system comprising: a storage unit resting on a leg; a feeder coupling the storage unit to a first input of a mixer; a pump coupled to a second input of the mixer; wherein the storage unit contains a solid component of a well treatment fluid; wherein the feeder supplies the solid component of the well treatment fluid to the mixer; wherein the pump supplies a fluid component of the well treatment fluid to the mixer; and wherein the mixer outputs a well treatment fluid.

In another exemplary embodiment, the present invention is directed to an integrated material processing system comprising: a plurality of storage units coupled to a frame; and a pump coupled to each of the plurality of storage units; wherein the pump is operable to pump out a fluid from its corresponding storage unit.

The features and advantages of the present disclosure will be readily apparent to those skilled in the art upon a reading of the description of exemplary embodiments, which follows.

### DESCRIPTION

The present invention relates generally to oilfield operations, and more particularly, to methods and systems for integrally processing the materials used in oilfield operations.

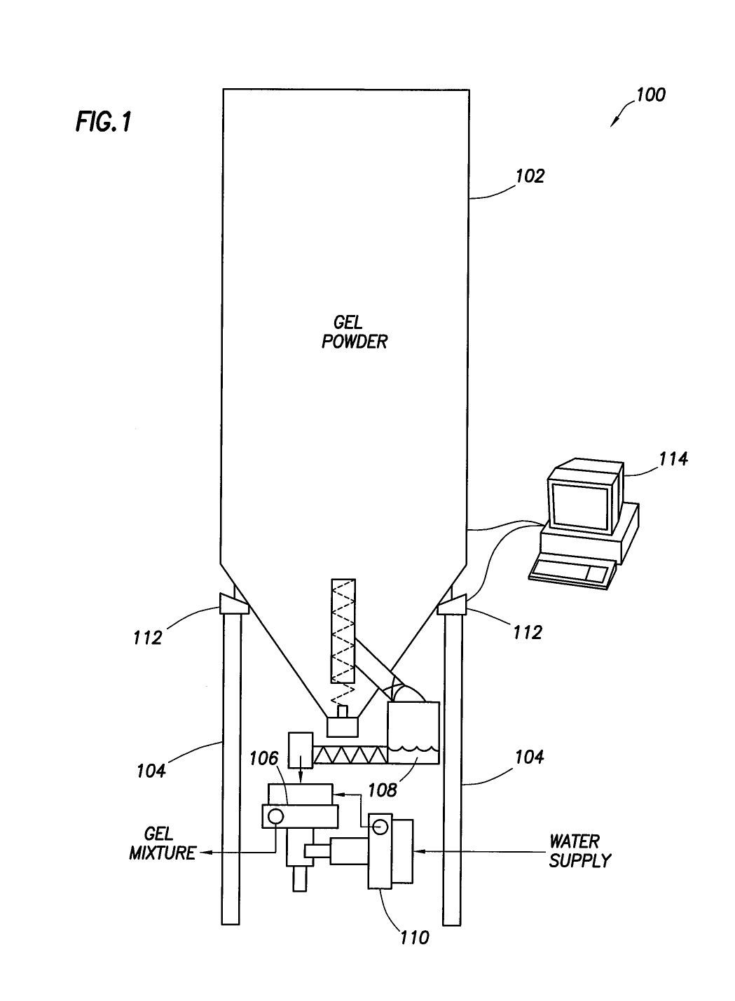

Turning now to FIG. 1, an Integrated Material Processing System (IMPS) in accordance with an exemplary embodiment of the present invention is depicted generally with reference numeral 100. The IMPS 100 may be used for preparing any desirable well treatment fluids such as a fracturing fluid, a sand control fluid or any other fluid requiring hydration time. The IMPS 100 comprises a storage unit 102 resting on legs 104. As would be appreciated by those of ordinary skill in the art, the storage unit may be a storage bin, a tank, or any other desirable storage unit. The storage unit 102 may contain the gel powder used for preparing the gelled fracturing fluid. As would be appreciated by those of ordinary skill in the art, with the benefit of this disclosure, the gel powder may comprise a dry polymer. Specifically, the dry polymer may comprise a number of different materials, including, but not limited to wg18, wg35, wg36 (available from Halliburton Energy Services of Duncan, Okla.) or any other guar or modified guar gelling agents. The materials from the storage unit 102 may be directed to a mixer 106 as a first input through a feeder 108. As would be appreciated by those of ordinary skill in the art, with the benefit of this disclosure, in one embodiment, the mixer 106 may be a growler mixer and the feeder 108 may be a screw feeder which may be used to provide a volumetric metering of the materials directed to the mixer 106. A water pump 110 may be used to supply water to the mixer 106 as a second input. A variety of different pumps may be used as the water pump 110 depending on the user preferences. For instance, the water pump 110 may be a centrifugal pump, a progressive cavity pump, a gear pump or a peristaltic pump. The mixer 106 mixes the gel powder from the storage unit 102 with the water from the water pump 110 at the desired concentration and the finished gel is discharged from the mixer 106 and may be directed to a storage unit, such as an external frac tank (not shown), for hydration.

In one exemplary embodiment, the legs 104 of the storage unit 102 are attached to load sensors 112 to monitor the reaction forces at the legs 104. The load sensor 112 readings may then be used to monitor the change in weight, mass and/or volume of materials in the storage unit 102. The change in weight, mass or volume can be used to control the metering of material from the storage unit 102 at a given setpoint. As a result, the load sensors 112 may be used to ensure the availability of materials during oilfield operations. In one exemplary embodiment, load cells may be used as load sensors 112. Electronic load cells are preferred for their accuracy and are well known in the art, but other types of force-measuring devices may be used. As will be apparent to one skilled in the art, however, any type of load-sensing device can be used in place of or in conjunction with a load cell. Examples of suitable load-measuring devices include weight-, mass-, pressure- or force-measuring devices such as hydraulic load cells, scales, load pins, dual sheer beam load cells, strain gauges and pressure transducers. Standard load cells are available in various ranges such as 0-5000 pounds, 0-10000 pounds, etc.

In one exemplary embodiment the load sensors 112 may be communicatively coupled to an information handling system 114 which may process the load sensor readings. Although FIG. 1 depicts a personal computer as the information handling system 114, as would be apparent to those of ordinary skill in the art, with the benefit of this disclosure, the information handling system 114 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the information handling system 114 may be a network storage device, or any other suitable device and may vary in size, shape, performance, functionality, and price. For instance, in one exemplary embodiment, the information handling system 114 may be used to monitor the amount of materials in the storage unit 102 over time and/or alert a user when the contents of the storage unit 102 reaches a threshold level. The user may designate a desired sampling interval at which the information handling system 114 may take a reading of the load sensors 112. The information handling system 114 may then compare the load sensor readings to the threshold value to determine if the threshold value is reached. If the threshold value is reached, the information handling system 114 may alert the user. In one embodiment, the information handling system 114 may provide a real-time visual depiction of the amount of materials contained in the storage unit 102. Moreover, as would be appreciated by those of ordinary skill in the art, with the benefit of this disclosure, the load sensors 112 may be coupled to the information handling system 114 through a wired or wireless (not shown) connection.

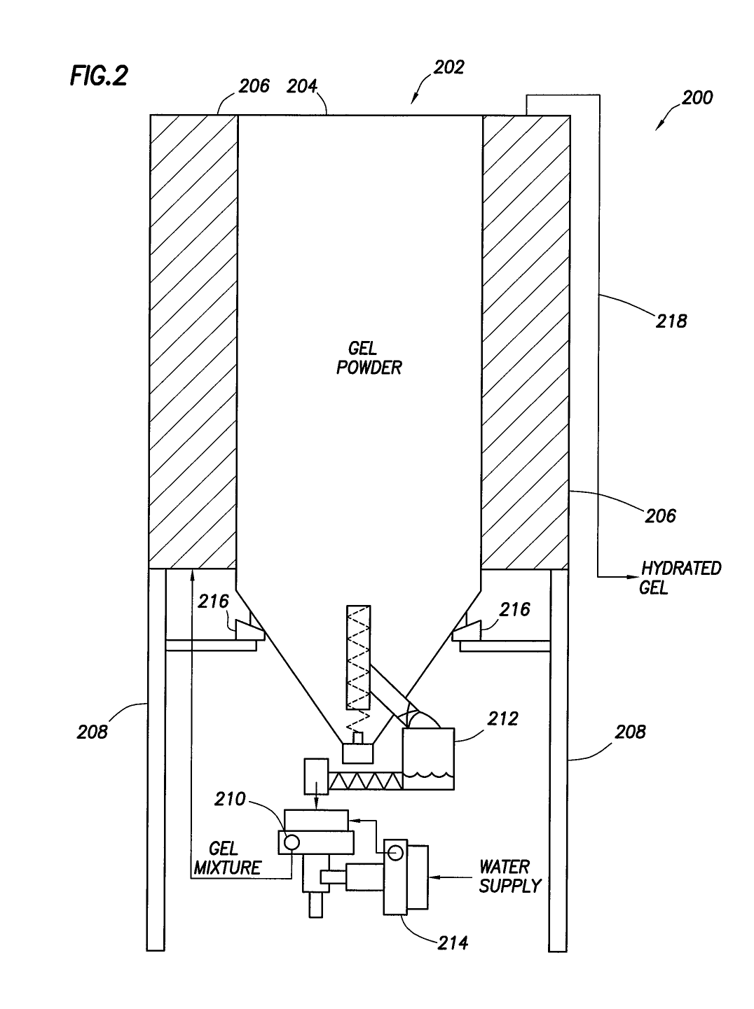

FIG. 2 depicts an IMPS in accordance with a second exemplary embodiment of the present invention, denoted generally by reference numeral 200. The IMPS 200 comprises a storage unit 202 resting on legs 208. The storage unit 202 in this embodiment may include a central core 204 for storage and handling of materials. In one embodiment, the central core 204 may be used to store a dry gel powder for making gelled fracturing fluids. The storage unit 202 may further comprise an annular space 206 for hydration volume. As would be appreciated by those of ordinary skill in the art, with the benefit of this disclosure, the gel powder may comprise a dry polymer. Specifically, the dry polymer may comprise a number of different materials, including, but not limited to wg18, wg35, wg36 (available from Halliburton Energy Services of Duncan, Okla.) or any other guar or modified guar gelling agents. The materials from the central core 204 of the storage unit 202 may be directed to a mixer 210 as a first input through a feeder 212. As would be appreciated by those of ordinary skill in the art, with the benefit of this disclosure, in one embodiment, the mixer 210 may be a growler mixer and the feeder 212 may be a screw feeder which may be used to provide a volumetric metering of the materials directed to the mixer 210. A water pump 214 may be used to supply water to the mixer 210 as a second input. A variety of different pumps may be used as the water pump 214 depending on the user preferences. For instance, the water pump 214 may be a centrifugal pump, a progressive cavity pump, a gear pump or a peristaltic pump. The mixer 210 mixes the gel powder from the storage unit 202 with the water from the water pump 214 at the desired concentration and the finished gel is discharged from the mixer 210. As discussed above with reference to FIG. 1, the storage unit 202 may rest on load sensors 216 which may be used for monitoring the amount of materials in the storage unit 202. The change in weight, mass or volume can be used to control the metering of material from the storage unit 202 at a given setpoint.

In this embodiment, once the gel having the desired concentration is discharged from the mixer 210, it is directed to the annular space 206. The gel mixture is maintained in the annular space 206 for hydration. Once sufficient time has passed and the gel is hydrated, it is discharged from the annular space 206 through the discharge line 218.

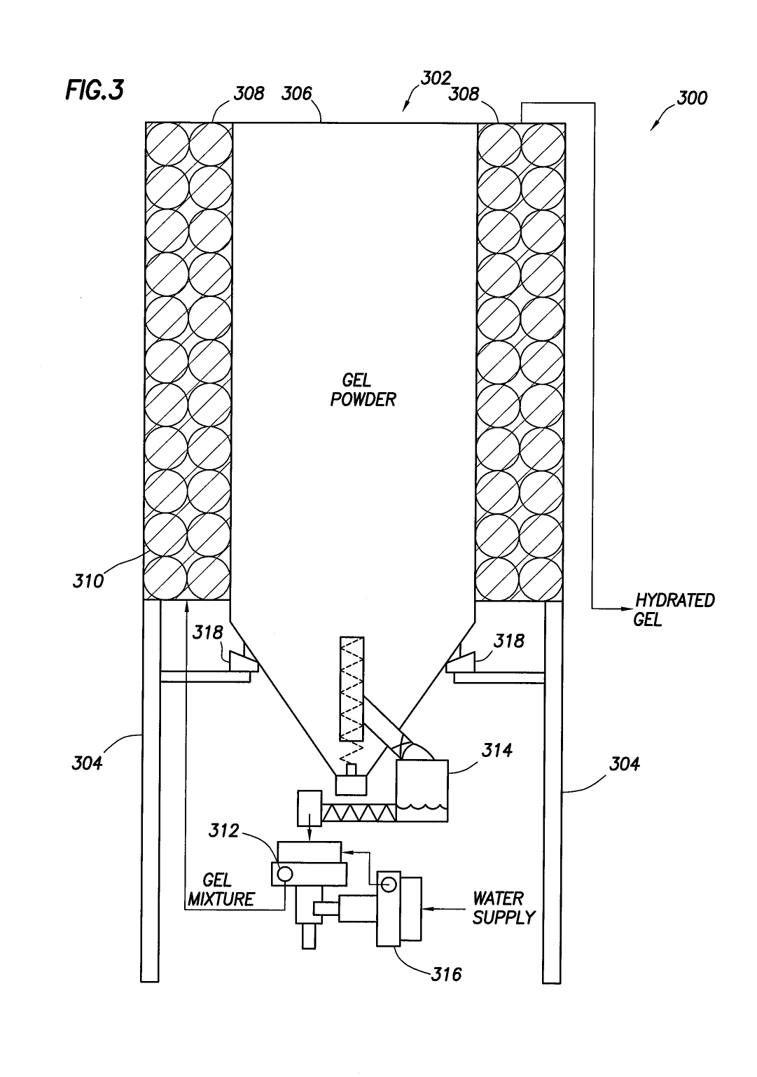

FIG. 3 depicts a cross section of a storage unit in an IMPS 300 in accordance with a third exemplary embodiment of the present invention. The IMPS 300 comprises a storage unit 302 resting on legs 304. The storage unit 302 in this embodiment may include a central core 306 for storage and handling of materials. In one embodiment, the central core 306 may be used to store a dry gel powder for making gelled fracturing fluids. As would be appreciated by those of ordinary skill in the art, with the benefit of this disclosure, the gel powder may comprise a dry polymer. Specifically, the dry polymer may comprise a number of different materials, including, but not limited to wg18, wg35, wg36 (available from Halliburton Energy Services of Duncan, Okla.) or any other guar or modified guar gelling agents. The storage unit 302 may further comprise an annular space 308 which may be used as a hydration volume. In this embodiment, the annular space 308 contains a tubular hydration loop 310.

The materials from the central core 306 of the storage unit 302 may be directed to a mixer 312 as a first input through a feeder 314. As would be appreciated by those of ordinary skill in the art, with the benefit of this disclosure, in one embodiment, the mixer 312 may be a growler mixer and the feeder 314 may be a screw feeder which may be used to provide a volumetric metering of the materials directed to the mixer 312. A water pump 316 may be used to supply water to the mixer 312 as a second input. A variety of different pumps may be used as the water pump 316 depending on the user preferences. For instance, the water pump 316 may be a centrifugal pump, a progressive cavity pump, a gear pump or a peristaltic pump. The mixer 312 mixes the gel powder from the storage unit 302 with the water from the water pump 316 at the desired concentration and the finished gel is discharged from the mixer 312. As discussed above with reference to FIG. 1, the storage unit 302 may rest on load sensors 318 which may be used for monitoring the amount of materials in the storage unit 302. The change in weight, mass or volume can be used to control the metering of material from the storage unit 202 at a given setpoint.

In this embodiment, once the gel having the desired concentration is discharged from the mixer 312, it is directed to the annular space 308 where it enters the tubular hydration loop 310. As would be appreciated by those of ordinary skill in the art, with the benefit of this disclosure, the portions of the gel mixture are discharged from the mixer 312 at different points in time, and accordingly, will be hydrated at different times. Specifically, a portion of the gel mixture discharged from the mixer 312 into the annular space 308 at a first point in time, t1, will be sufficiently hydrated before a portion of the gel mixture which is discharged into the annular space 308 at a second point in time, t2. Accordingly, it is desirable to ensure that the gel mixture is transferred through the annular space 308 in a First-In-First-Out (FIFO) mode. To that end, in the third exemplary embodiment, a tubular hydration loop 310 is inserted in the annular space 308 to direct the flow of the gel as it is being hydrated.

As would be appreciated by those of ordinary skill in the art, with the benefit of this disclosure, in order to achieve optimal performance, the tubular hydration loop 310 may need to be cleaned during a job or between jobs. In one embodiment, the tubular hydration loop 310 may be cleaned by passing a fluid such as water through it. In another exemplary embodiment, a pigging device may be used to clean the tubular hydration loop 310.

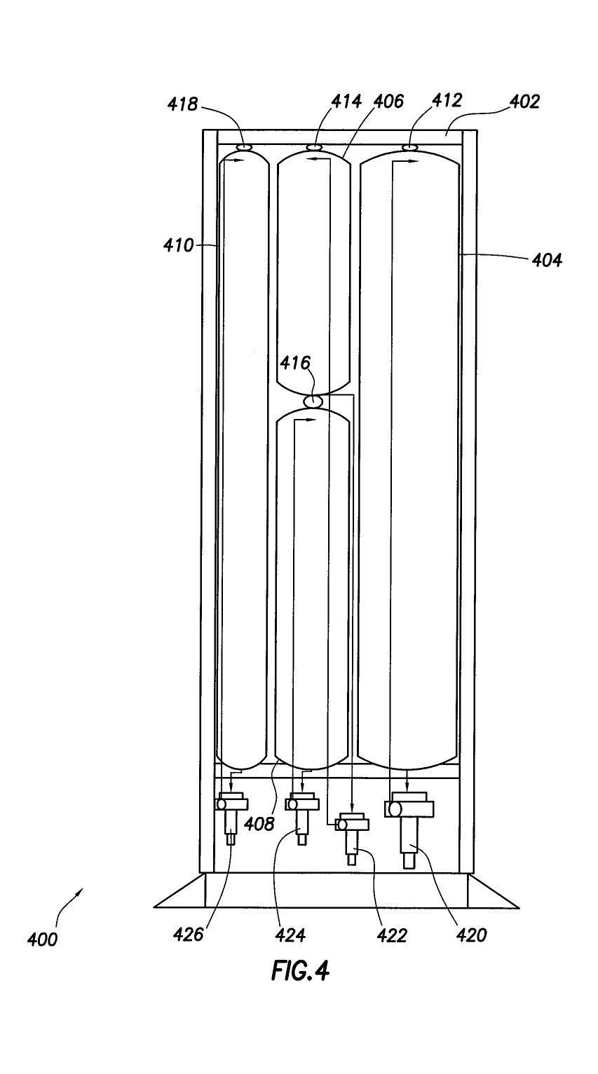

FIG. 4, depicts an IMPS in accordance with another exemplary embodiment of the present invention, denoted generally by reference numeral 400. In this embodiment, the IMPS 400 includes a frame 402 which may support a plurality of storage units 404, 406, 408 and 410. As depicted in FIG. 4, some of the storage units 404, 406 and 410 may directly hang from the frame 402, while others such as 408 may be attached to the frame 402 through another storage unit 406. The frame 402 may also prevent collisions between the storage units 404, 406, 408 and 410 and keep the storage units 404, 406, 408 and 410 in position as the IMPS 400 is lowered into its horizontal position for transportation or raised into its vertical position. In one exemplary embodiment, rub blocks may be used to prevent the collision of the storage units 404, 406, 408 and 410.

In one embodiment, the storage units 404, 406, 408 and 410 may be storage tanks used for storing the chemical additives used in oilfield operations for well treatment. As would be appreciated by those of ordinary skill in the art, with the benefit of this disclosure, such chemical additives may include, but are not limited to, surfactants, cross-linkers, breakers, or any other desirable chemical additives. In one embodiment, a load sensor 412, 414, 416 and 418 may be coupled to each storage unit 404, 406, 408 and 410, respectively, at the location where the storage unit is hanging from the frame 402 or another storage unit 406. In one exemplary embodiment, load cells may be used as load sensors. Electronic load cells are preferred for their accuracy and are well known in the art, but other types of force-measuring devices may be used. As will be apparent to one skilled in the art, however, any type of load-sensing device can be used in place of or in conjunction with a load cell. Examples of suitable load-measuring devices include weight-, mass-, pressure- or force-measuring devices such as hydraulic load cells, scales, load pins, dual sheer beam load cells, strain gauges and pressure transducers.

As discussed above with reference to FIG. 1, the load sensors 412, 414, 416 and 418 may be communicatively coupled to an information handling system (not shown) which may process the load sensor readings. For instance, the user may designate a sampling interval at which the information handling system may take the readings of the load sensors. That information may then be used to provide real-time monitoring of individual storage tanks or groups of storage tanks. The change in weight, mass or volume can be used to control a flow control valve at a given flow rate or flow ratio setpoint. As would be appreciated by those of ordinary skill in the art, with the benefit of this disclosure, the information handling system may be programmed to account for the impact of having one storage tank hanging from another. Specifically, where a storage unit 408 is supported by another storage unit 406, the output of the load sensors 414 and 416 may be used to monitor the individual storage units 406 and 408. Accordingly, in one embodiment, the information handling system may provide a visual representation of the contents of the storage tanks.

In one exemplary embodiment, the information handling system may alert a user when the contents of a storage unit reach a threshold weight, mass and/or volume designated by a user based on system requirements. Moreover, as would be appreciated by those of ordinary skill in the art, with the benefit of this disclosure, the load sensors may be coupled to the information handling system through a wired or wireless connection.

Additionally, each storage unit 404, 406, 408 and 410 may be coupled to a pump 420, 422, 424 and 426 respectively. As would be appreciated by those of ordinary skill in the art, with the benefit of this disclosure, the pumps 420, 422, 424 and 426 may be any suitable pump. For instance, the pumps 420, 422, 424 and 426 may be a centrifugal pump, a progressive cavity pump, a gear pump or a peristaltic pump.

Although FIG. 4 depicts four storage units, the present invention is not limited by the number of storage units in the IMPS. Moreover, although FIG. 4 depicts the storage units hanging from load sensors, as would be appreciated by those of ordinary skill in the art, with the benefit of this disclosure, in another exemplary embodiment, the storage units 404, 406, 408 and 410 may instead rest on load sensors.

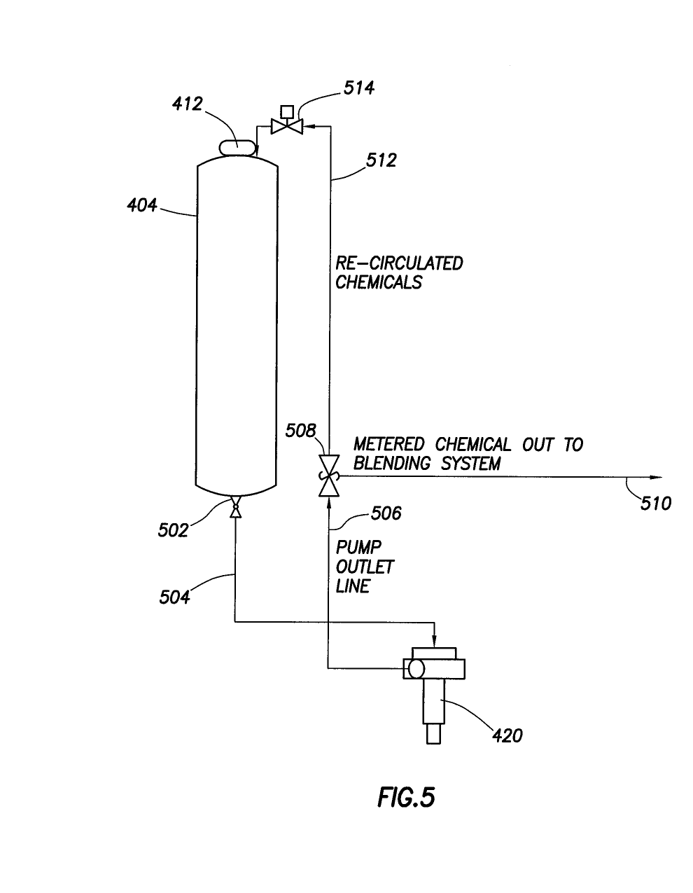

FIG. 5 depicts an exemplary embodiment of one of the storage units 404 of the IMPS 400 of FIG. 4 which may contain chemical additives. The storage unit 404 hangs from a load sensor 412 at the top and is coupled to a pump 420 through a suction valve 502 and the chemical pump supply line 504. A pump outlet line 506 directs the chemical additives from the storage unit 404 to a three way valve 508. As discussed with reference to FIG. 4, a number of different pumps may be used depending on system requirements. As would be appreciated by those of ordinary skill in the art, with the benefit of this disclosure, the type of pump used may depend, among other factors, on the amount of pressure which the pump must deliver. The amount of pressure required may depend, for instance, on the friction losses in the system and the pressure of the system to which the chemical additives are being added.

The first output 510 of the three way valve 508 directs the chemicals out to a desired location such as a blending system (not shown). As would be appreciated by those of ordinary skill in the art, with the benefit of this disclosure, a metering device (not shown) may be used to control the amount of chemicals directed to the first output 510. A second output 512 from the three way valve 508 recirculates the excess chemical additives back to the storage unit 404 through a back pressure valve 514. Accordingly, the chemical additives contained in the tank 404 may be continuously circulated through the system with desired amounts being metered out through the three way valve 508 and the first output 510. As discussed above, the load sensor 412 may be used to keep track of material usage and alert the operator when the weight, mass, and/or volume of the chemical additives in the storage unit reaches a designated threshold value. While a three way valve is depicted in this embodiment, in another exemplary embodiment the three way valve may be replaced with a tee that connects the pump outlet line 506 to the first output 510 and the second output 512. As would be appreciated by those of ordinary skill in the art, with the benefit of this disclosure, when the three way valve 508 is replaced with a tee section, a back pressure valve 514 in the second output 512 and a flow control valve (not shown) in the first output 510 may be used to control the flow of materials.

As would be appreciated by those of ordinary skill in the art, with the benefit of this disclosure, the different equipment used in an IMPS in accordance with the present invention may be powered by any suitable power source. For instance, the equipment may be powered by a combustion engine, electric power supply which may be provided by an on-site generator or by a hydraulic power supply. As would be appreciated by those of ordinary skill in the art, with the benefit of this disclosure, in each exemplary embodiment, the IMPS may be transported as a single unit by lowering it into a horizontal position on a vehicle such as a truck or a trailer. In one embodiment, the storage unit may be a self-erecting storage unit as disclosed in U.S. patent application Ser. No. 12/235,270, assigned to Halliburton Energy Services, Inc., which is incorporated by reference herein in its entirety. Accordingly, the legs of the storage unit may be specially adapted to connect to a vehicle which may be used to lower, raise and transport the storage unit. Once at a jobsite, the storage unit may be erected and filled with a desired amount of a desired material.

Therefore, the present invention is well-adapted to carry out the objects and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects. The terms in the claims have their plain, ordinary meaning unless otherwise explicitly and clearly defined by the patentee.

What is claimed is:

1. An integrated material processing system comprising:
a storage unit resting on a leg;
a feeder coupling the storage unit to a first input of a mixer;
a pump coupled to a second input of the mixer;
wherein the storage unit contains a solid component of a well treatment fluid;
wherein the feeder supplies the solid component of the well treatment fluid to the mixer;
wherein the pump supplies a fluid component of the well treatment fluid to the mixer; and
wherein the mixer outputs a well treatment fluid.

2. The system of claim 1, wherein the well treatment fluid is a gelled fracturing fluid.

3. The system of claim 2, wherein the solid component is a gel powder.

4. The system of claim 2, wherein the fluid component is water.

5. The system of claim 1, wherein the storage unit comprises a central core and an annular space.

6. The system of claim 5, wherein the central core contains the solid component of the well treatment fluid.

7. The system of claim 5, wherein the well treatment fluid is directed to the annular space.

8. The system of claim 5, wherein the annular space comprises a tubular hydration loop.

9. The system of claim 8, wherein the well treatment fluid is directed from the mixer to the tubular hydration loop.

10. The system of claim 1, wherein the well treatment fluid is selected from the group consisting of a fracturing fluid and a sand control fluid.

11. The system of claim 1, further comprising a power source to power at least one of the feeder, the mixer and the pump.

12. The system of claim 11, wherein the power source is selected from the group consisting of a combustion engine, an electric power supply and a hydraulic power supply.

13. The system of claim 1, further comprising a load sensor coupled to the leg.

14. The system of claim 13, further comprising an information handling system communicatively coupled to the load sensor.

15. The system of claim 13, wherein the load sensor is a load cell.

16. An integrated material processing system comprising:
a plurality of storage units coupled to a frame;
a pump coupled to each of the plurality of storage units;
wherein the pump is operable to pump out a fluid from its corresponding storage unit.

17. The system of claim 16, wherein the integrated material processing system is transportable as a single unit.

18. The system of claim 16, wherein at least one of the plurality of the storage units is a storage tank.

19. The system of claim 18, wherein the storage tank contains chemical additives.

20. The system of claim 19, wherein the chemical additives are selected from the group consisting of a surfactant, a cross-linker and a breaker.

21. The system of claim 16, further comprising:
a tank suction valve coupled to at least one of the plurality of storage units;
wherein the tank suction valve directs the fluid from the at least one of the plurality of storage units to the pump;
a three way valve coupled to an output of the pump;
wherein the pump pumps the fluid from the at least one of the plurality of storage units to the three way valve;
wherein a first output of the three way valve is directed to a blending system; and
wherein a second output of the three way valve is recirculated to the at least one of the plurality of storage units.

22. The system of claim 21, wherein the second output of the three way valve is directed to the at least one of the plurality of storage units through a back pressure valve.

23. The system of claim 16, wherein each of the plurality of storage units may be supported by the frame through another one of the plurality of the storage units.

24. The system of claim 16, wherein each of the plurality of storage units is coupled to a load sensor.

25. The system of claim 16, wherein the load sensor is a load cell.

26. The system of claim 25, wherein the load sensor is communicatively coupled to an information handling system.

27. The system of claim 16, further comprising:
a tank suction valve coupled to at least one of the plurality of storage units;
wherein the tank suction valve directs the fluid from the at least one of the plurality of storage units to the pump;
a tee section coupled to an output of the pump;
wherein the pump pumps the fluid from the at least one of the plurality of storage units to the tee section;
wherein a first output of the tee section is directed to a blending system;
wherein a first valve controls fluid flow to the first output;
wherein a second output of the tee section is recirculated to the at least one of the plurality of storage units; and
wherein a second valve controls fluid flow to the second output.
